(19) United States
(12) Patent Application Publication
(10) Pub. No.: US 2009/0013366 A1
(43) Pub. Date: Jan. 8, 2009

(54) METHOD AND APPARATUS FOR TRANSMITTING AND RECEIVING DATA GENERATED ON APPLICATION ACCORDING TO HDMI CEC

(75) Inventors: Ho-jeong You, Suwon-si (KR); Jin-Woo Hong, Suwon-si (KR); Dae-gyu Bae, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 11/959,589

(22) Filed: Dec. 19, 2007

(30) Foreign Application Priority Data
Jul. 4, 2007 (KR) 10-2007-0067072

(51) Int. Cl. H04N 7/173

(52) U.S. Cl. 725/118; 725/131

(57) ABSTRACT

A method and apparatus for transmitting and receiving data generated on an application according to the High Definition Media Interface Consumer Electronics Control (HDMI CEC) standard are provided. The method and apparatus enable transmission and reception of audio, video and control signals through CEC of an integrated HDMI cable, without using a complicated TCP/IP structure. As a result, wiring is simple and Audio/Video (AV) devices are used dynamically.

### CROSS-REFERENCE TO RELATED APPLICATION

This application claims priority from Korean Patent Application No. 2007-0067072, filed Jul. 4, 2007 in the Korean Intellectual Property Office, the entire disclosure of which is hereby incorporated by reference.

### BACKGROUND OF THE INVENTION

1. Field of the Invention

Methods and apparatuses consistent with the present invention relate to data transmission and reception, and more particularly, to transmitting and receiving data generated on an application.

2. Description of the Related Art

High Definition Multimedia Interface (HDMI) is one of unencrypted, digital video/audio interface standards, which converts Digital Visual Interface (DVI), the interface standard for PCs and displays, for use as home AV systems.

Because a HDMI transmits uncompressed audio and video data in a bi-directional way between a transmitting device and a receiving device, it does not need decoder chips or software, and it enables the connected devices to perceive one another.

The HDMI Consumer Electronics Control (CEC) standard allows transmission of an audio, video and control signal through a single cable, and therefore, an Audio/Video (AV) system has simpler wiring. Additionally, the AV system can be dynamically used since it can send out a control signal too.

The HDMI CEC standard adopts Transition Minimized Differential Signaling (TMDS) for a physical layer, Display Data Channel for inter-device authentication, and CEC for the connection of the overall control system. That is, three independent channels are arranged in a single physical cable, and AV data, device information and control commands are transmitted and received through this single cable.

The HDMI CEC standard particularly allows performing the function of transmitting a control command between AV devices that are connected through a HDMI cable.

Meanwhile, many protocols operating on TCP/IP model application basically operate on the basis of TCP or UDP and IP.

A related art method for transmitting data generated on an application will be explained briefly below with reference to FIG. 1.

The protocol layer structure illustrated in FIG. 1 includes an application layer 10, a transmission layer 20, a network layer 30, and a link layer 40.

As mentioned above, many protocols that are used on an application layer 10 such as HTTP 11, RTSP 12, RTP 13, FTP 14, or TELENET 19 operate based on the TCP 21 or UDP 22 of a transmission layer 20, or on the IP 31 of a network layer 30. The application layer 10 provides a user with services, the transmission layer 20 transmits a message from one process to another process, and the network layer 30 transmits packets from a source to a final destination. Additionally, a link layer 40 transmits frames from one node to another.

As explained above, the TCP/IP protocol layer structure operates by dividing jobs and it provides a variety of functions. Therefore, a method to facilitate the operating of a protocol, which operates the protocol without requiring TCP 21 or UDP 22, and IP 31, is required.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

The present invention provides a method and apparatus for transmitting and receiving data generated on an application according to High Definition Multimedia Interface Consumer Electronics Control (HDMI CEC) standard, without using TCP/IP.

According to an aspect of the present invention, there is provided a method for transmitting data, including generating a control message in compliance with High Definition Multimedia Interface Consumer Electronics Control (HDMI CEC) standard, the control message including data generated on an application, and transmitting the generated control message.

The control message may include information about a protocol that is used in generating the data on the application.

The protocol may include at least one of HTTP, RTSP, RTCP, RTP, FTP, TELNET, and EMAIL.

The control message may include information indicating that the control message contains the data generated on the application.

The control message may include a logical address of a transmitting side and a logical address of a receiving side.

The control message may be transmitted through a different channel from video signals.

According to another aspect of the present invention, there is provided a method for receiving data, including receiving a control message in compliance with High Definition Multimedia Interface Consumer Electronics Control (HDMI CEC) standard, the control message including data generated on an application of a transmitting side, and transmitting the data included in the received control message to an application of a receiving side.

The control message may include information about a protocol that is used in generating the data on the application of the transmitting side.

The protocol may include at least one of HTTP, RTSP, RTCP, RTP, FTP, TELNET, and EMAIL.

The control message may include information indicating that the control message contains the data generated on the application of the transmitting side.

The control message may include a logical address of the transmitting side and a logical address of the receiving side.

The control message may be transmitted through a different channel from video signals.

According to another aspect of the present invention, there is provided a transmitting apparatus, including a High Definition Multimedia Interface Consumer Electronics Control (HDMI CEC) processor which generates a control message in compliance with the HDMI CEC standard, the control message including data generated on an application, and a HDMI interface which transmits the generated control message.

The control message may include information about a protocol that is used in generating the data on the application.

The control message may include information indicating that the control message contains the data generated on the application.

The control message may be transmitted through a different channel from video signals.

According to another aspect of the present invention, there is provided a receiving apparatus, including a High Definition Multimedia Interface Consumer Electronics Control (HDMI CEC) interface which receives a control message in compliance with the HDMI CEC standard, the control message including data generated on an application of a transmitting side, and a HDMI CEC processor which transmits the data included in the received control message to an application of a receiving side.

The control message may include information about a protocol that is used in generating the data on the application of the transmitting side.

The control message may include information indicating that the control message contains the data generated on the application of the transmitting side.

The control message may be received through a different channel from video signals.

### BRIEF DESCRIPTION OF THE DRAWINGS

The above and other aspects of the present invention will be more apparent from the following detailed description of exemplary embodiments with reference to the accompanying drawings, in which:

FIG. 1 illustrates a related art method for transmitting data generated on an application;

FIG. 2 is a block diagram of a video system according to an exemplary embodiment of the present invention;

FIG. 3 is provided to explain a method for transmitting and receiving data according to an exemplary embodiment of the present invention;

FIG. 4 illustrates a format of a HDMI CEC message;

FIG. 5 is provided to explain a method for transmitting data according to another exemplary embodiment of the present invention; and

FIG. 6 is provided to explain a method for receiving data according to yet another exemplary embodiment of the present invention.

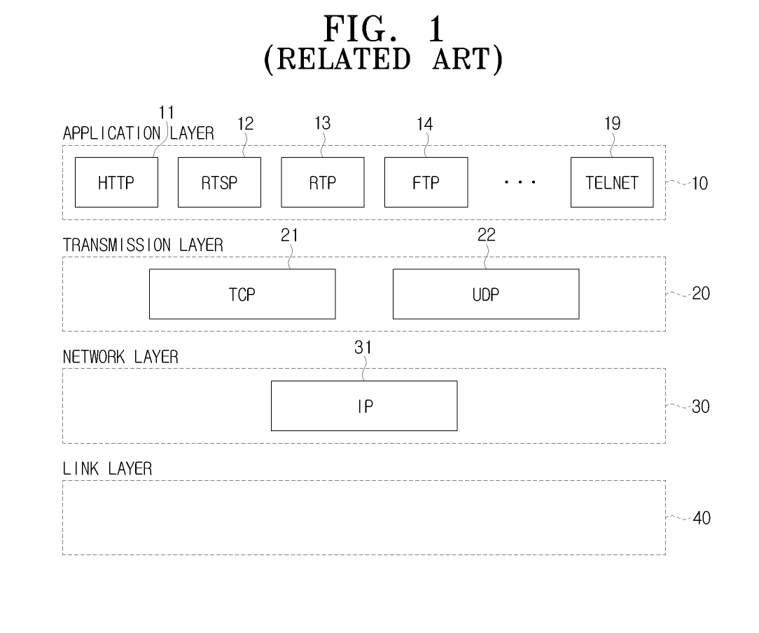

Throughout the drawings, the same drawing reference numerals will be understood to refer to the same elements, features, and structures.

### DETAILED DESCRIPTION OF EXEMPLARY EMBODIMENTS OF THE INVENTION

The matters defined in the description such as a detailed construction and elements are provided to assist in a comprehensive understanding of exemplary embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

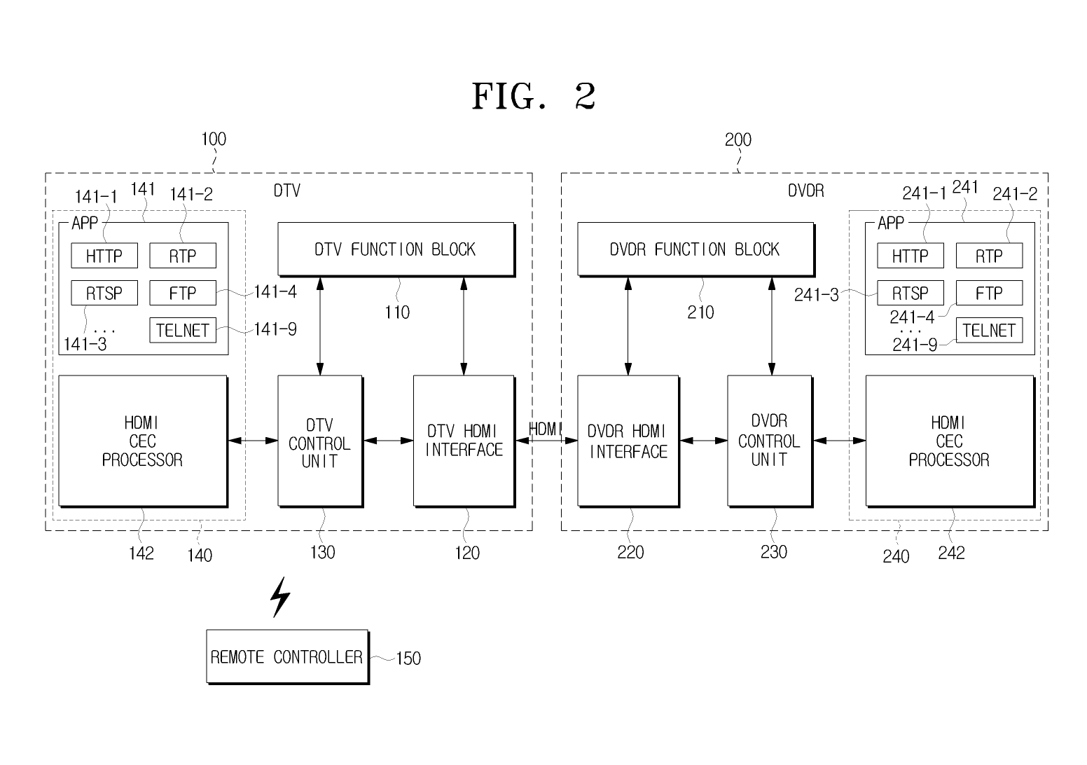

FIG. 2 is a block diagram of a video system according to an exemplary embodiment of the present invention.

Referring to FIG. 2, a video system includes a DTV 100 and a Digital Versatile Disc Recorder (DVDR) 200 that are connected with each other according to High Definition Multimedia Interface Consumer Electronics Control (HDMI CEC) standard.

The DTV 100 includes a DTV function block 110, a DTV HDMI interface 120, a DTV control unit 130, and a DTV memory 140. The DTV 100 receives user command through a remote controller 150.

The DTV function block 110 performs the basic function of a DTV. Accordingly, the DTV function block 110 conducts signal processing such as decoding and scaling with the signals being received from a broadcast station by wire or wirelessly, and displays the signals through a display for users to view. The DTV function block 110 may also display a video that corresponds to the video signal being transmitted from the DVDR 200 via the DTV HDMI 120.

The DTV HDMI interface 120 connects the DTV 100 and the DVDR 200 according to the HDMI CEC standard, so that the DTV 100 and the DVDR 200 can communicate with video signals and control messages.

The DTV control unit 130 controls the operation of the DTV function block 110 according to a user command as received through the remote controller 150. The DTV control unit 130 also transmits a control message to the DVDR 200 through the DTV HDMI interface 120 to control the operation of the DVDR 200.

The DTV memory 140 is a storage medium that stores an application 141 and a HDMI CEC processor 142. The application 141 is a program that is executed by the DTV control unit 130 to generate data according to a corresponding protocol. The application 141 may be classified into an HTTP-based application 141-1, an RTP-based application 141-2, an RTSP-based application 141-3, an FTP-based application 141-4, and a TELNET-based application 141-9.

The HDMI CEC processor 142 is a program that generates a HDMI CEC compliant control message (HDMI CEC message) that contains the data (application data) that is generated on the application 141, and transmits the generated HDMI CEC message to the DVDR 200 through the DTV HDMI interface 120.

The HDMI CEC message is transmitted through a different channel from the video signals.

Referring to FIG. 2, the DVDR 200 includes a DVDR function block 210, a DVDR HDMI interface 220, a DVDR control unit 230, and a DVDR memory 240.

The DVDR function block 210 performs basic functions of a DVDR. Accordingly, the DVDR function block 210 operates to record a broadcast being input from the DTV 100 through the DVDR HDMI interface 220 onto a mounted DVD, or to read in video signal from the mounted DVD and provide the DTV 100 with the video signal via the DVDR HDMI interface 220.

The DVDR HDMI interface 220 is connected with the DTV 100 according to the HDMI CEC standard, so that the DTV 100 and the DVDR 200 can communicate with each other with video signals and control messages.

The DVDR control unit 230 controls the operation of the DVDR function block 210 according to the HDMI CEC message being transmitted by the DTV control unit 130 through the DVDR HDMI interface 220. The HDMI CEC message is received through a different channel from the video signals.

The DVDR memory 240 is a storage medium that stores an application 241 and a HDMI CEC processor 242. The HDMI CEC processor 242 is a program that is executed by the DVDR control unit 230, to extract application data from the HDMI CEC message being received from the DTV 100 through the DVDR HDMI interface 220. As mentioned above, the HDMI CEC processor 242 extracts the data generated on the application 141 of the DTV 100.

The application 241 is a program that is executed by the DVDR control unit 230, to process application data being extracted by the HDMI CEC processor 242. Like the application 141 of the DTV 100, the application 241 of the DVDR 200 may be classified into an HTTP-based application 241-1, an RTP-based application 241-2, an RTSP-based application 241-3, an FTP-based application 241-4, and a TELNET-based application 241-9.

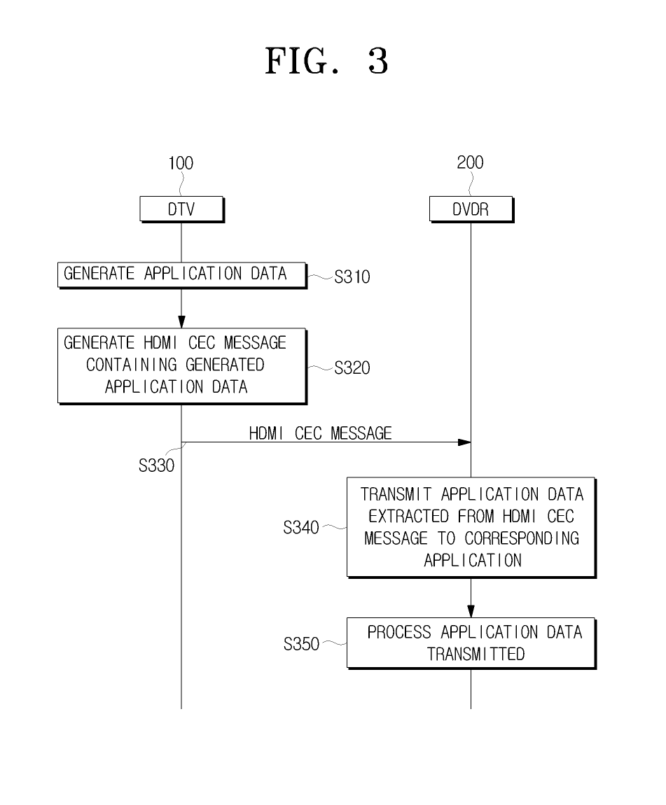

An exemplary embodiment where the HDMI CEC processor 142 transmits the application data generated on the application 141 of the DTV 100 to the DVDR 200 according to the HDMI CEC standard, and where the HDMI CEC processor 242 of the DVDR 200 extracts application data from a received HDMI CEC message and processes the extracted application data will be explained in greater detail below with reference to FIGS. 2 and 3.

FIG. 3 is provided to explain a method for transmitting and receiving data according to an exemplary embodiment of the present invention.

Referring to FIG. 3, the DTV control unit 130 of the DTV 100 generates application data by executing the application 141 at operation S310. At operation S320, the DTV control unit 130 generates a HDMI CEC message that contains the application data, by executing the HDMI CEC processor 142.

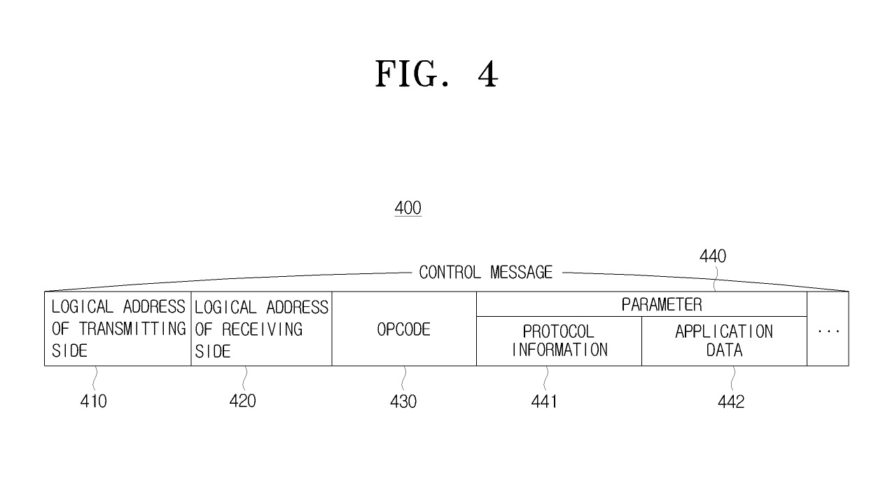

The process of generating a HDMI CEC message that contains application data will be explained in more detail with reference to FIG. 4 that illustrates the format of a HDMI CEC message.

Referring to FIG. 4, the HDMI CEC message 400 may be divided into three areas, namely, an address indicative of logical addresses of a transmitting side 410 and a receiving side 420, an OPCODE 430, and a parameter 440.

A 4-bit address may be used as the logical addresses of the transmitting side and the receiving side. For example, if a logical address of a transmitting side is 10, and a logical address of a receiving side is 6, and if logical addresses of the DTV 100 and the DVDR 200 are 10 and 6, respectively, the HDMI CEC message 400 is transmitted from the DTV 100 to the DVDR 200.

The OPCODE 430 indicates that the parameter 440 contains application data. The OPCODE 430 is used because it is necessary to inform the DVDR 200 (that is, receiving side) that the HDMI CEC message 400 contains application data.

The parameter 440 may be divided into protocol information 441 and application data 442. The protocol information 441 gives information as to which protocols the application data 442 is generated from.

In particular, the protocol information 441 indicates a basis protocol used to generate the application data 442, that is, it indicates a basis protocol of an application from which the application data 442 is generated. For example, if the HTTP-based application 141-1 generated the application data 442, the protocol information 441 indicates “HTTP,” and if the FTP-based application 141-4 generated the application data 442, the protocol information 441 indicates “FTP.”

Therefore, the protocol information 441 may include one of HTTP, RTSP, RTCP, RTP, FTP and TELNET. The protocol information area 441 may be 1-byte long, and may designate HTTP, RTSP, RTCP, RTP, FTP, and TELNET in 0 to 5.

Therefore, it is necessary to transmit the protocol information 441 together with the application data 442. In other words, the HDMI CEC message 400 needs to include the protocol information 441.

Referring back to FIG. 3, operations after S320 will be explained below.

At operation S330, the DTV control unit 130, which is currently running the HDMI CEC processor 142, transmits the HDMI CEC message 400 generated from operation S320 to the DVDR 200 through the DTV HDMI interface 120. Accordingly, the DVDR control unit 230 receives the HDMI CEC message 400 through the DVDR HDMI interface 220.

At operation S340, the HDMI CEC processor 242 executed by the DVDR control unit 230 extracts the application data 442 from the HDMI CEC message 400, and transmits the extracted application data 442 to a corresponding application.

In other words, the HDMI CEC processor 242 transmits the application data 442 to one of the applications 241-1, 241-2, 241-3, . . . , 241-9, with reference to the protocol information 441 included in the HDMI CEC message 400.

For example, if the protocol information 441 indicates “HTTP,” the HDMI CEC processor 242 transmits the application data 442 to the HTTP-based application 241-1. If the protocol information 441 indicates “FTP,” the HDMI CEC processor 242 transmits the application data 442 to the FTP-based application 241-4.

At operation S350, the application processes the received application data.

Accordingly, the HDMI CEC processor 142 transmits the application data being generated by the application 141 of the DTV 100 to the DVDR 200 according to the HDMI CEC standard. The HDMI CEC processor 242 of the DVDR 200 extracts the application data from the received HDMI CEC message, and the application processes the extracted application data.

The exemplary embodiment of transmitting and receiving the application data generated on the application of the DTV 100 to and from the DVDR 200 through the DTV 100 has been explained so far.

Although the exemplary embodiment set forth above defined HTTP, RTP, RTSP, FTP and TELNET as application protocols, this is only for the exemplary purpose, and one will understand that the technical concept of the present invention is equally applicable to other types of application protocols such as EMAIL protocol, or the like.

Further, although FIGS. 2 and 3 exemplify the video system having the DTV 100 and the DVDR 200 connected with each other, one will understand that the technical concept of the present invention is equally applicable to the video systems that include other types of video devices. For example, the video devices such as Settop box (STB), DVD player (DVDP), Digital Video Recorder (DVR), Personal Video Recorder (PVR), Hard Disk Drive (HDD), Blu-ray Disk (BD) player, BD recorder, Video Cassette Recorder (VCR), home theater system, Personal Multimedia Player (PMP), digital camera or digital camcorder may be implemented in the video system.

Although the exemplary embodiments set forth above illustrated that the HDMI CEC message generated from the DTV 100 is transmitted to the DVDR 200, one will understand that this is exemplified so for a convenient explanation. Therefore, the invention should not be construed as limiting to certain examples set forth above. For example, the technical concept of the present invention is equally applicable to when a HDMI CEC message generated from the DVDR 200 is transmitted to the DTV 100.

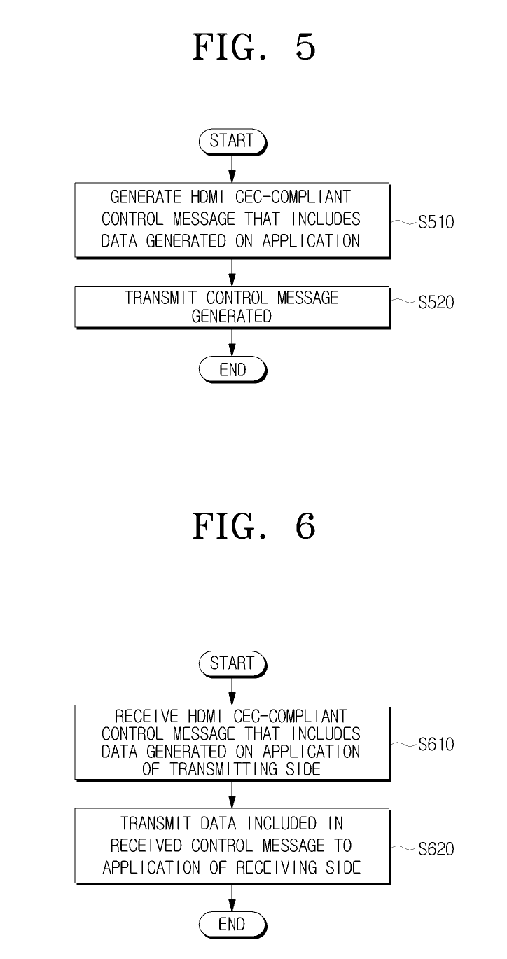

Other exemplary embodiments of the present invention will now be explained below with reference to FIGS. 5 and 6. Referring to FIG. 5 which illustrates a method for transmitting the data, a transmitting side at operation S510 generates a HDMI CEC-compliant control message that includes the data generated from the application. At operation S520, the transmitting side transmits the generated control message to a receiving side.

FIG. 6 illustrates a receiving method according to another exemplary embodiment of the present invention. Referring to FIG. 6, the receiving side at operation S610 receives a HDMI CEC-compliant control message that includes the data generated from the application of the transmitting side. At operation S620, the receiving side transmits the data included in the received control message to the application of the receiving side.

As explained above, the exemplary embodiments of the present invention provide advantages of high speed AV data transmission, because it is possible to transmit the data using HDMI CEC, TCP/IP is unnecessary. Because video, audio and control signals are transmitted through an integrated CEC of HDMI cable, instead of using complicated TCP/IP structure, advantages such as simple wiring and dynamic use of AV devices are provided.

While certain exemplary embodiments of the present invention have been shown and described with reference to certain preferred embodiments thereof, it will be understood by those skilled in the art that various changes in form and details may be made therein without departing from the spirit and scope of the invention as defined by the appended claims and their equivalents.

What is claimed is:

1. A method for transmitting data, comprising:
generating a control message in compliance with High Definition Multimedia Interface Consumer Electronics Control (HDMI CEC) standard, the control message including data generated on an application; and
transmitting the generated control message.

2. The method of claim 1, wherein the control message comprises information about a protocol that is used in generating the data on the application.

3. The method of claim 2, wherein the protocol comprises at least one of HTTP, RTSP, RTCP, RTP, FTP, TELNET, and EMAIL.

4. The method of claim 1, wherein the control message comprises information indicating that the control message contains the data generated on the application.

5. The method of claim 1, wherein the control message comprises a logical address of a transmitting side and a logical address of a receiving side.

6. The method of claim 1, wherein the control message is transmitted through a different channel from video signals.

7. A method for receiving data, comprising:
receiving a control message in compliance with High Definition Multimedia Interface Consumer Electronics Control (HDMI CEC) standard, the control message including data generated on an application of a transmitting side; and
transmitting the data included in the received control message to an application of a receiving side.

8. The method of claim 7, wherein the control message comprises information about a protocol that is used in generating the data on the application of the transmitting side.

9. The method of claim 8, wherein the protocol comprises at least one of HTTP, RTSP, RTCP, RTP, FTP, TELNET, and EMAIL.

10. The method of claim 7, wherein the control message comprises information indicating that the control message contains the data generated on the application of the transmitting side.

11. The method of claim 7, wherein the control message comprises a logical address of the transmitting side and a logical address of the receiving side.

12. The method of claim 7, wherein the control message is received through a different channel from video signals.

13. A transmitting apparatus, comprising:
a High Definition Multimedia Interface Consumer Electronics Control (HDMI CEC) processor which generates a control message in compliance with the HDMI CEC standard, the control message including data generated on an application; and
a HDMI interface which transmits the generated control message.

14. The apparatus of claim 13, wherein the control message comprises information about a protocol that is used in generating the data on the application.

15. The apparatus of claim 13, wherein the control message comprises information indicating that the control message contains the data generated on the application.

16. The apparatus of claim 13, wherein the control message is transmitted through a different channel from video signals.

17. A receiving apparatus, comprising:
a High Definition Multimedia Interface Consumer Electronics Control (HDMI CEC) interface which receives a control message in compliance with the HDMI CEC standard, the control message including data generated on an application of a transmitting side; and
a HDMI CEC processor which transmits the data included in the received control message to an application of a receiving side.

18. The apparatus of claim 17, wherein the control message comprises information about a protocol that is used in generating the data on the application of the transmitting side.

19. The apparatus of claim 17, wherein the control message comprises information indicating that the control message contains the data generated on the application of the transmitting side.

20. The apparatus of claim 17, wherein the control message is received through a different channel from video signals.
